(19) United States
(12) Patent Application Publication
(10) Pub. No.: US 2016/0118912 A1
(43) Pub. Date: Apr. 28, 2016

(54) Electrostatic Induction Type Electromechanical Transducer and Nano Tweezers

(71) Applicant: AOI Electronics Co., Ltd., Takamatsu-shi, Kagawa (JP)

(72) Inventor: Hiroki HAYASHI, Takamatsu-shi (JP)

(21) Appl. No.: 14/892,908

(22) PCT Filed: Jan. 28, 2014
(86) PCT No.: PCT/JP2014/051816

§ 371 Date: Nov. 20, 2015

(30) Foreign Application Priority Data
May 22, 2013 (JP) 2013-108275

(51) Int. Cl. H02N 1/08

(52) U.S. Cl. CPC H02N 1/08

(57) ABSTRACT

An electrostatic induced type electromechanical transducer includes: a first electrode having a plurality of first comb tooth electrodes; a second electrode having a plurality of second comb tooth electrodes arranged meshed with the plurality of first comb tooth electrodes through respective gaps; a plurality of dielectric members at an electric field formation space between the first comb tooth electrodes and the second comb tooth electrodes and made of a material having a relative dielectric constant greater than 1; and a base that fixedly supports or movably supports the first electrode, the second electrode, and the dielectric members, wherein the first electrode and/or the second electrode, and the dielectric members are capable of being relatively displaced from each other.

### TECHNICAL FIELD

The present invention relates to an electrostatic induction type electromechanical transducer and nano tweezers.

### BACKGROUND ART

Conventionally, comb teeth have been fabricated by anisotropically etching monocrystalline silicon to produce an electrostatic actuator. As disclosed in PTL 1, an inorganic oxide film may be formed on the lateral side of the electrostatic actuator to form an electrolet. In particular, in vibration driven power generation or electrostatic transduction using an electrostatic actuator, the higher the electric field is, the more increased the electromechanical coupling factor is. Accordingly, it is desirable to apply high voltage or increase the capacitance between the comb teeth at the time of charging in the electret formation.

### CITATION LIST

### Patent Literature

PTL1: JP 2013-013256 A

### SUMMARY OF INVENTION

### Technical Problem

However, application of high voltage at the time of charging may cause the comb teeth to be pulled in and become unseparated from each other. In addition, to increase the electrostatic capacitance, it is required to arrange the comb teeth to have narrow gaps between them. However, formation of comb teeth through narrow gaps between them causes pull-in to occur more often.

### Solution to Problem

According to the 1st aspect of the present invention, an electrostatic induced type electromechanical transducer comprises: a first electrode having a plurality of first comb tooth electrodes; a second electrode having a plurality of second comb tooth electrodes arranged meshed with the plurality of first comb tooth electrodes through respective gaps; a plurality of dielectric members at an electric field formation space between the first comb tooth electrodes and the second comb tooth electrodes and made of a material having a relative dielectric constant greater than 1; and a base that fixedly supports or movably supports the first electrode, the second electrode, and the dielectric members, wherein the first electrode and/or the second electrode, and the dielectric members are capable of being relatively displaced from each other.

According to the 2nd aspect of the present invention, it is preferred that in the electrostatic induced type electromechanical transducer according to the 1st aspect, the base fixedly supports the first electrode and the dielectric members and movably supports the second electrode.

According to the 3rd aspect of the present invention, it is preferred that in the electrostatic induced type electromechanical transducer according to the 1st aspect, the base fixedly supports the first electrode and the second electrode and movably supports the dielectric members.

According to the 4th aspect of the present invention, it is preferred that in the electrostatic induced type electromechanical transducer according to the 2nd or 3rd aspect, the dielectric members are arranged in the respective gaps between the first comb tooth electrodes and the second comb tooth electrodes.

According to the 5th aspect of the present invention, it is preferred that in the electrostatic induced type electromechanical transducer according to the 2nd aspect, the dielectric members are each arranged opposite to a front edge of each of the second comb tooth electrodes through a gap; and the second electrode is movably supported and capable of being displaced in a direction orthogonal to both a first direction from the front edge of each of the second comb tooth electrodes toward the dielectric members and a second direction from the second comb tooth electrodes toward the first comb tooth electrodes.

According to the 6th aspect of the present invention, it is preferred that in the electrostatic induced type electromechanical transducer according to any one of the 2nd to 5th aspects, kinetic energy of the second electrode or the dielectric members being movably supported is converted into electric energy and is output.

According to the 7th aspect of the present invention, it is preferred that in the electrostatic induced type electromechanical transducer according to any one of the 1st to 6th aspects, on a surface of at least one of the first comb tooth electrodes or the second comb tooth electrodes is formed of an electret made of a SiO₂ layer containing alkali ions.

According to the 8th aspect of the present invention, it is preferred that the electrostatic induced type electromechanical transducer according to the 2nd aspect may further comprise: a third electrode having a plurality of third comb tooth electrodes arranged at the base; and a fourth electrode having a plurality of fourth comb tooth electrodes arranged meshed with the plurality of third comb tooth electrodes through respective gaps and provided at the movable part, wherein the plurality of dielectric members and the second electrode are fixed to the fixed part and a boosted output is taken out from the third electrode.

According to the 9th aspect of the present invention, nano tweezers comprises: a pair of grippers being openable and closable; the electrostatic induced type electromechanical transducer according to the 4th aspect provided in correspondence to at least one of the pair of grippers; and a drive control unit that applies voltage between the first electrode and the second electrode of the electrostatic induced type electromechanical transducer to control the electrostatic induced type electromechanical transducer to drive the grippers to open or close.

### Advantageous Effects of Invention

The present invention enables electrostatic induction type electromechanical transducers to have increased electrostatic capacitance and an increased change in electrostatic capacitance.

### BRIEF DESCRIPTION OF DRAWINGS

FIG. 1 is a diagram showing the arrangement of the electrostatic induction type electromechanical transducer 1 according to the present invention;

FIG. 2 is a diagram showing the basic arrangement of a conventional electrostatic induction type electromechanical transducer 100 having a comb tooth structure;

FIG. 3 is a schematic diagram illustrating the electrostatic capacitance of the comb tooth structures shown in FIGS. 1 and 2;

FIG. 4 is a diagram showing the structure shown in FIG. 3 having a varied overlap area;

FIG. 5A is a diagram illustrating a first step of the manufacturing method;

FIG. 5B is a diagram illustrating a second step of the manufacturing method;

FIG. 5C is a diagram illustrating a third step of the manufacturing method;

FIG. 5D is a diagram illustrating a fourth step of the manufacturing method;

FIG. 5E is a diagram illustrating a fifth step of the manufacturing method;

FIG. 5F is a diagram illustrating a sixth step of the manufacturing method;

FIG. 5G is a diagram illustrating a seventh step of the manufacturing method;

FIG. 5H is a diagram illustrating an eighth step of the manufacturing method;

FIG. 6A is a diagram illustrating a method of forming isolated comb teeth 113 by using a resist;

FIG. 6B is a diagram illustrating a step next to the step in FIG. 6A;

FIG. 7 is a diagram illustrating a first example;

FIG. 8 is a diagram illustrating a second example;

FIG. 9 is a diagram illustrating a method of manufacturing an electret;

FIG. 10 is a diagram illustrating charging process;

FIG. 11 is a diagram showing a first variation example of the electrostatic induction type electromechanical transducer 1;

FIG. 12 is a diagram showing a second variation example of the electrostatic induction type electromechanical transducer 1;

FIG. 13 is a diagram showing a third variation example of the electrostatic induction type electromechanical transducer 1;

FIG. 14 is a diagram showing a fourth variation example of the electrostatic induction type electromechanical transducer 1;

FIG. 15 is a diagram illustrating a third example; and

FIG. 16 is a diagram showing the skeleton arrangement of a capacitor type microphone.

### DESCRIPTION OF EMBODIMENTS

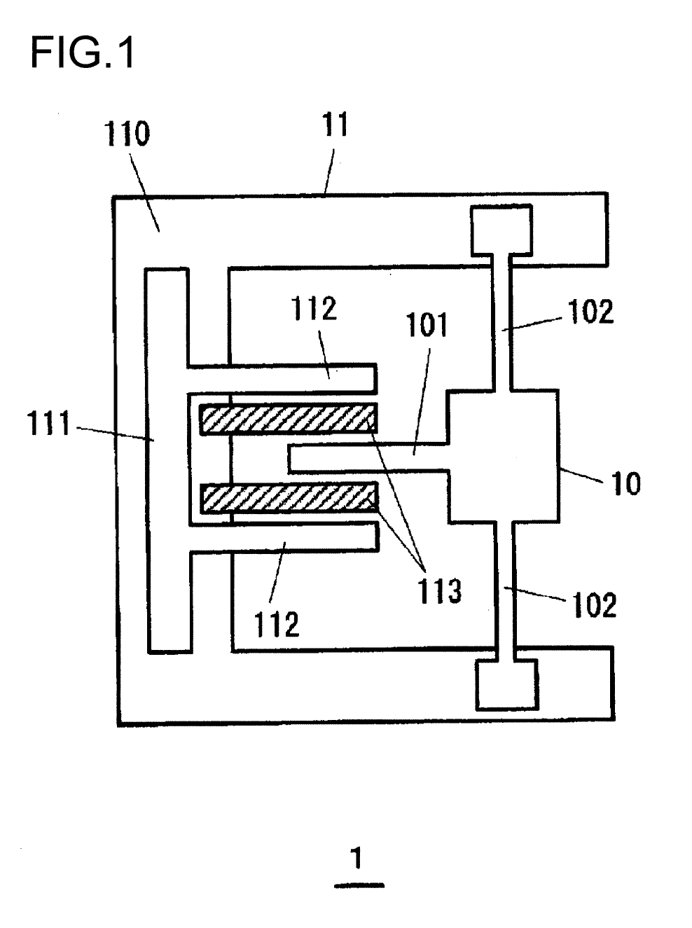

Hereinafter, embodiments of the present invention are explained with reference to the attached drawings. First, with reference to FIGS. 1 to 4, the basic concept of the electrostatic induction type electromechanical conversion element is explained.

FIG. 1 is a diagram showing the arrangement of the electrostatic induction type electromechanical transducer 1 according to the present invention. The electrostatic induction type electromechanical transducer 1 has a movable part 10 and a fixed part 11. The fixed part 11 includes a base 110, a fixed electrode 111 fixed to the base 110, and isolated comb teeth 113. As described later, an insulating layer is formed between the base 110 and the fixed electrode 111 and between the base 110 and the isolated comb teeth 113, respectively. Thus, the fixed electrode 111 and the isolated comb teeth 113 are electrically insulated from each other. The fixed electrode 111, which is made of an electroconductive material, is provided with a plurality of comb tooth electrodes 112 that protrude toward the movable part.

On the other hand, the movable part 10, which is made of an electroconductive material, is fixed to the base 110 via a resilient support 102 having a relatively small width. An insulating layer is formed also between the base 110 and the movable part 10. On a lateral side of the movable part 10 is formed a plurality of comb tooth electrodes 101 that protrude toward the fixed electrode 111. On the other hand, the fixed electrode 111 is formed of a plurality of comb tooth electrodes 112 that protrude toward the movable part 10. Each comb tooth electrode 101 is arranged so that it is inserted between a pair of comb tooth electrodes 112. The isolated comb teeth 113 are each arranged between one comb tooth electrode 112 and one comb tooth electrode 101 through respective gaps. As is described later, insulating layers are provided between the base 110 and any of the movable part 10, the fixed electrode 111 and the isolated comb teeth 113 so that the movable part 10, the fixed electrode 111 and the isolated comb tooth 113 are insulated with respect to one another.

Although details are described later, in case the electrostatic induced type electromechanical transducer 1 shown in FIG. 1 is used as an actuator that converts electric energy into mechanical energy, electric power is input on the side of the fixed part to drive the movable part 10. In case the electrostatic induced type electromechanical transducer 1 is used as a power generator that converts mechanical energy into electric energy, the movable part is displaced by external force to output electric power from the side of the fixed part.

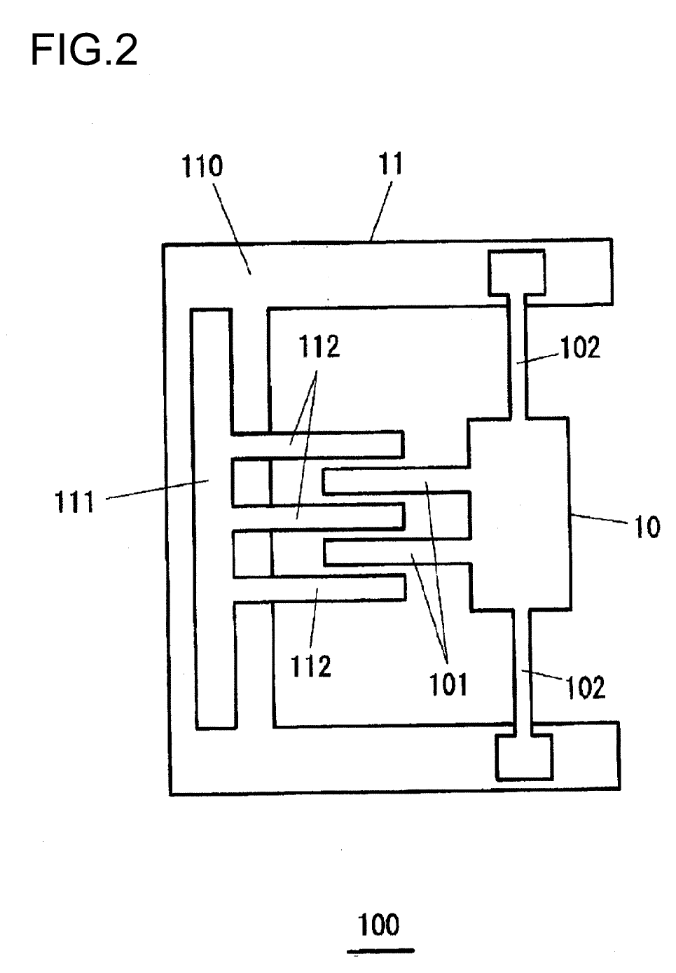

FIG. 2 shows the basic arrangement of a conventional electrostatic induced type electromechanical transducer 100 having a comb tooth structure, as a comparison. The comb teeth structures shown in FIGS. 1 and 2 differ from each other in whether isolated comb teeth 113 are used. In FIG. 2, parts that are the same as or similar to those shown in FIG. 1 are designated by the same reference signs as those used in FIG. 1. The arrangement shown in FIG. 2 includes no isolated comb teeth 113 and accordingly allows more comb tooth electrodes 101 and 112 to be provided if they have the same size as those in the arrangement shown in FIG. 1.

(Explanation of Principle)

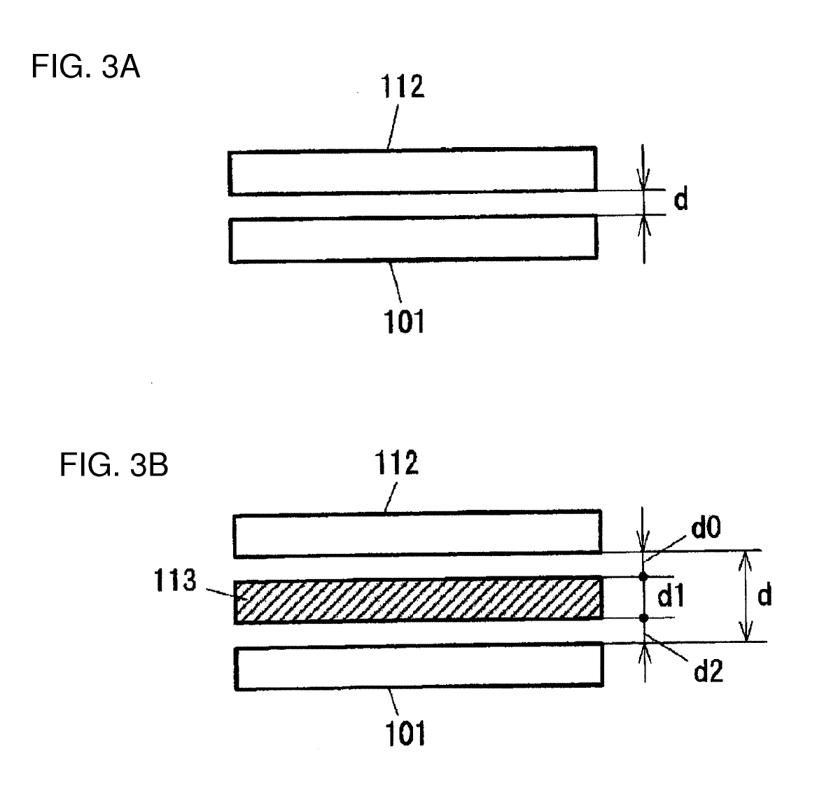

FIGS. 3(a) and (b) are schematic diagrams illustrating the electrostatic capacitance of the comb structures shown in FIGS. 1 and 2. The model shown in FIG. 3(a) corresponds to a unit capacitor structure that includes one comb tooth electrode 101 and one comb tooth electrode 112 shown in FIG. 2. This model corresponds to the case in which the overlap between the comb tooth electrodes 101 and 112 is maximal. The model shown in FIG. 3(b) corresponds to a unit capacitor structure in the case shown in FIG. 1. In this case, the isolated comb tooth 113 is arranged between the comb tooth electrode 101 and the comb tooth electrode 112. The distance between the pair of comb tooth electrodes 101 and 112 is set to a size d. The electrostatic capacitance C1 of the structure shown in FIG. 3(a) is expressed by formula (1) below, which represents the electrostatic capacitance of parallel plates. In the formula (1), ε0 represents the dielectric constant of vacuum.

$$\begin{matrix}[ Math . 1 ] & \\ {C}_{1} = \frac{{ɛ}_{0} S}{d} & ( 1 )\end{matrix}$$

On the other hand, FIG. 3(b) corresponds to the structure shown in FIG. 1 in which the isolated comb tooth 113 is arranged between the comb tooth electrodes 101 and 112. The distance between the comb tooth electrode 101 and the isolated comb tooth 113 is d2 and the distance between the comb tooth electrode 112 and the isolated comb tooth 113 is d0. The size in thickness of the isolated comb tooth 113 is d1. That is, the distance d between the comb tooth electrodes 101 and 112 is expressed by d=d0+d1+d2.

In this case, in the structure shown in FIG. 3(b), a space corresponding to just a portion d1 out of the space corresponding to the distance d between the electrodes can be deemed to have an increased relative dielectric constant due to presence of a portion that has a relatively high relative dielectric constant. That is, the portions corresponding to d0 and d2 have a dielectric constant that is unchanged from the dielectric constant of vacuum whereas the portion corresponding to d1 has a dielectric constant, which is a product of the dielectric constant of vacuum with a relative dielectric constant. Given this perspective, the electrostatic capacitance C2 between the comb tooth electrodes 101 and 112 is given by the following formula (2). In the formula (2), εr represents the relative dielectric constant of the material that constitutes the isolated comb tooth 113. If εr>1, the electrostatic capacitance given by the formula (2) is greater than the electrostatic capacitance given by the formula (1). The materials having dielectric constants satisfying εr>1 that can be used for the isolated comb tooth 113 include dielectric materials, for instance, silicon, silicon oxide film, resist, fluororesin, and titanium oxide.

$$\begin{matrix}[ Math . 2 ] & \\ {C}_{2} = \frac{{ɛ}_{0} ( ( d - {d}_{1} ) + {ɛ}_{r} {d}_{1} ) S}{{d}^{2}} & ( 2 )\end{matrix}$$

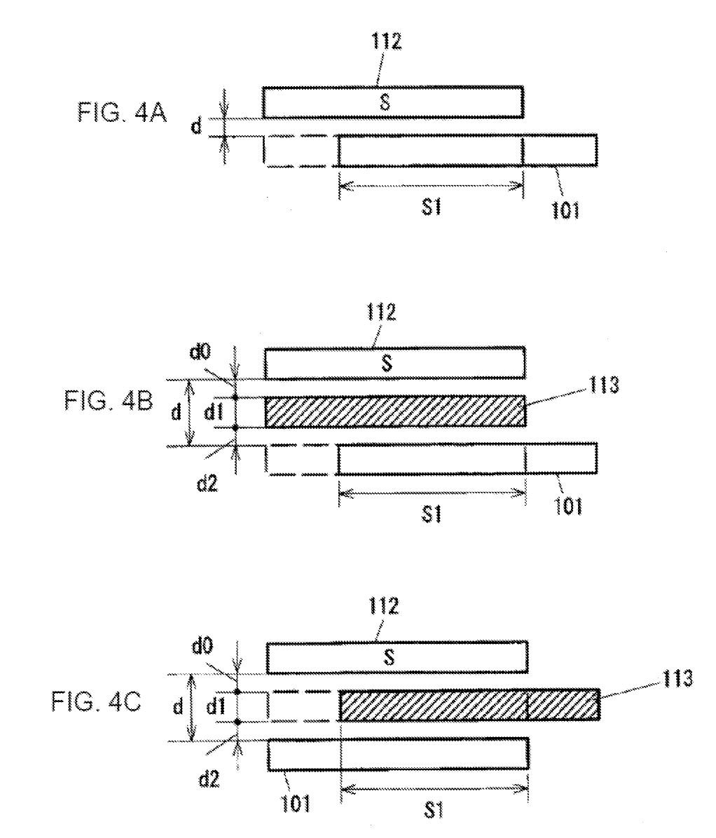

The movable part 10 on which the comb tooth electrode or electrodes 101 are formed is movable in a horizontal direction in the figure as shown in FIGS. 1 and 2. The states that are shown in FIG. 3(a) and FIG. 3(b) have each the largest electrostatic capacitance. If the comb tooth electrode or electrodes 101 are displaced rightward from the state that is shown in FIG. 3(a) to the state that is shown in FIG. 4(a), the electrostatic capacitance decreases. The change in capacitance ΔC1 is given by the following formula (3). S1 represents the area of the overlapping portion between the comb tooth electrode 101 and the comb tooth electrode 112 in the state that is shown in FIG. 4(a).

$$\begin{matrix}[ Math . 3 ] & \\ Δ {C}_{1} = \frac{{ɛ}_{0} ( S - {S}_{1} )}{d} & ( 3 )\end{matrix}$$

Displacement of the comb tooth electrode 101 rightward from the state that is shown in FIG. 3(b) to the state that is shown in FIG. 4(b) gives a change in capacitance ΔC2 represented by the following formula (4). S1 represents the area of the overlapping portion between the comb tooth electrode 101 and the comb tooth electrode 112 in the state that is shown in FIG. 4(b).

$$\begin{matrix}[ Math . 4 ] & \\ \begin{matrix}Δ {C}_{2} = \frac{{ɛ}_{0} ( ( d - {d}_{1} ) + {ɛ}_{r} {d}_{1} ) S}{{d}^{2}} - \frac{{ɛ}_{0} ( ( d - {d}_{1} ) + {ɛ}_{r} {d}_{1} ) {S}_{1}}{{d}^{2}} \\ = \frac{{ɛ}_{0} ( ( d - {d}_{1} ) + {ɛ}_{r} {d}_{1} ) ( S - {S}_{1} )}{{d}^{2}}\end{matrix} & ( 4 )\end{matrix}$$

In the example that is shown in FIG. 1, the isolated comb teeth 113 are fixed to the base 110. If the relationships among the comb tooth electrodes 101 and 112 and the isolated comb teeth 113 change as shown in FIG. 4(c), the electrostatic capacitance C2 then is expressed by the following formula (5). In this case, the change in capacitance ΔC2 is represented by the following formula (6).

$$\begin{matrix} [ Math . 5 ] & \\ {C}_{2} = \frac{{ɛ}_{0} ( S - {S}_{1} )}{d} + \frac{{ɛ}_{0} ( ( d - {d}_{1} ) + {ɛ}_{r} {d}_{1} ) {S}_{1}}{{d}^{2}} & ( 5 ) \\ Δ {C}_{2} = \frac{{ɛ}_{0} ( ( d - {d}_{1} ) + {ɛ}_{r} {d}_{1} ) S}{{d}^{2}} - ( \frac{{ɛ}_{0} ( S - {S}_{1} )}{d} + \frac{{ɛ}_{0} ( ( d - {d}_{1} ) + {ɛ}_{r} {d}_{1} ) {S}_{1}}{{d}^{2}} ) & ( 6 )\end{matrix}$$

If specific values are assigned to the formulas, electrostatic capacitance C and amounts of changes in capacitance, ΔC1 and ΔC2, for the cases that are shown in FIG. 4(a) to FIG. 4(c), respectively, are given as follows. Comparison of FIG. 1 with FIG. 2 indicates that the number of unit capacitor structures, each including one comb tooth electrode 101 and one comb tooth electrode 112 (that is, the structures shown in FIG. 3(a) and FIG. 3(b)), is larger in the structure that is shown in FIG. 2 than in the structure that is shown in FIG. 1.

Here, calculation is performed on the following assumptions. That is, the comb tooth electrodes 101 and 112 in FIG. 3(a) have a size in thickness of 20 μm and an area S at an opposite side face of 100 μm×200 μm. The area S1 of the overlap in FIG. 4 is S1=S/2. In addition, the arrangement shown in FIG. 1 includes 250 unit capacitor structures and the arrangement shown in FIG. 2 (conventional arrangement) includes 500 capacitor structures.

(Arrangement Shown in FIG. 4(a))
d=10 μm=10×10⁻⁶ m
S (in total)=500×100×10⁻⁶×200×10⁻⁶
S1 (in total)=500×100×10⁻⁶×200×10⁻⁶×1/2
ε0≈(nearly equal to) 8.85×10⁻¹²
Plug in these values to the formulae (1) and (3) to obtain:
C1≈(nearly equal to) 8.9×10⁻¹² F=8.9 pF
ΔC1≈(nearly equal to) 4.4 pF
   (Arrangement Shown in FIG. 4(b))
d=40 μm, d1=20 μm, d0=d2=10 μm
S (in total)=250×100×10⁻⁶×200×10⁻⁶
S1 (in total)=250×100×10⁻⁶×200×10⁻⁶×1/2
ε0≈(nearly equal to) 8.85×10⁻¹²
εr≈(nearly equal to) 16
Plug in these values to the formulae (2) and (4) to obtain:
C≈(nearly equal to) 9.4×10⁻¹² F=9.4 pF
ΔC ≈(nearly equal to) 4.7 pF
   (Arrangement Shown in FIG. 4(c))
d=40 εm, d1=20 εm, d0=d2=10 μm
S (in total)=250×100×10⁻⁶×200×10⁻⁶
S1 (in total)=250×100×10⁻⁶×200×10⁻⁶×1/2
ε0≈(nearly equal to) 8.85×10⁻¹²
εr≈(nearly equal to) 18
Plug in these values to the formulae (2) and (6) to obtain:
C≈(nearly equal to) 1.1×10⁻¹² F=1.1 pF
ΔC≈(nearly equal to) 4.7 pF

As described above, arranging the isolated comb tooth 113 having a dielectric constant greater than 1 between the comb tooth electrode 101, which constitutes the electrode on the movable side, and the comb tooth electrode 112, which constitutes the electrode on the fixed side, enables the transducer to have increased electrostatic capacitance and an increased change in electrostatic capacitance. Setting εr to satisfy εr≧16 for the arrangement shown in FIG. 4(b) and to satisfy εr≧18 for the arrangement shown in FIG. 4(c) enables the transducer to have electrostatic capacitance and a change in electrostatic capacitance greater than those provided by the arrangement shown in FIG. 4(a). In particular, the above settings enable the gap between the electrodes upon charging to be broadened and thus enable increased voltage to be applied. This increases capacitance and much more increases the electromechanical coupling factor. On the contrary, in an environment in which no high voltage can be applied, a change in capacitance per unit area can be increased.

The arrangement shown in FIG. 4(b) disallows relative movement of the isolated comb tooth 113 with respect to the comb tooth electrode 112. This enables the gap size d0 between the comb tooth electrode 112 and the isolated comb tooth 113 to be as small as possible. For instance, use of the MEMS processing technology enables a reduction in gap size to a size on the order of 0.1 μm. A portion of the space saved by setting d0=0.1 μm may be used to increase the thickness of the isolated comb tooth 113 to, for instance, d1=20.9 μm or to increase the number of the comb tooth electrodes. This enables adoption of smaller εr.

In the arrangement shown in FIG. 4(c), both a positive electrode and a ground electrode serve as comb tooth electrodes on the fixed side. This arrangement is highly resistant to pull-in. In this regard, however, it is necessary to set εr to a value greater than that of εr for the arrangement that is shown in FIG. 4(b).

In case the electromechanical transducer is used in acoustic pressure sensors and vibration-driven power generators and so on, the magnitude of electrostatic capacitance and the amount of the change in electrostatic capacitance ΔC may influence the output impedance and current value. Consequently, the arrangement that is shown in FIG. 4(b) is preferred than the arrangement that is shown in FIG. 4(c).

(Manufacturing Method for Electrostatic Induced Type Electromechanical Transducer)

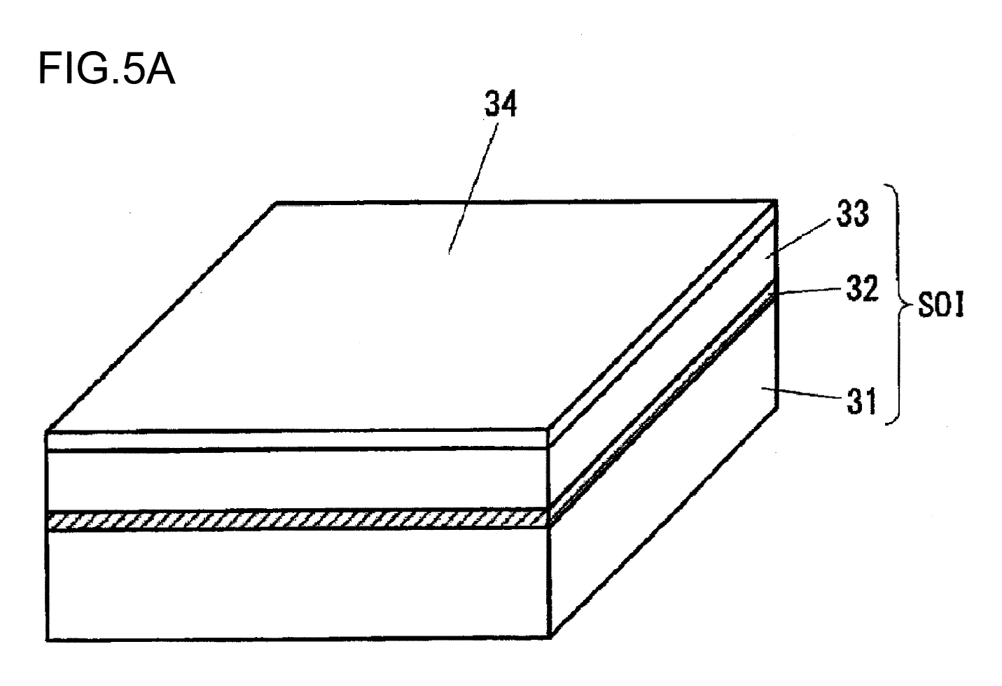

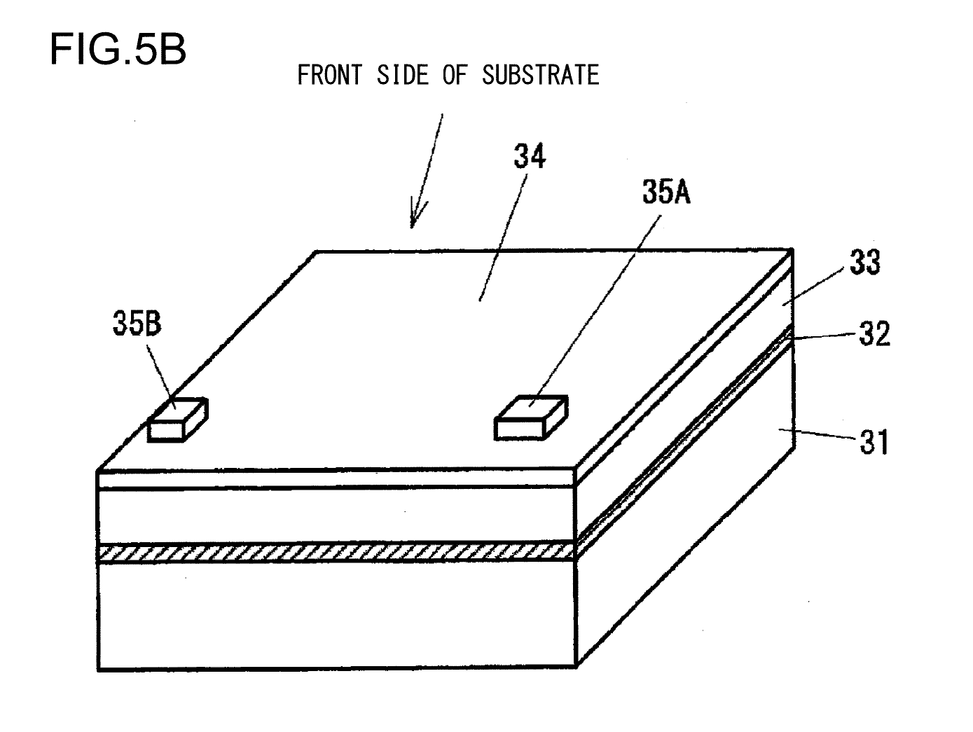

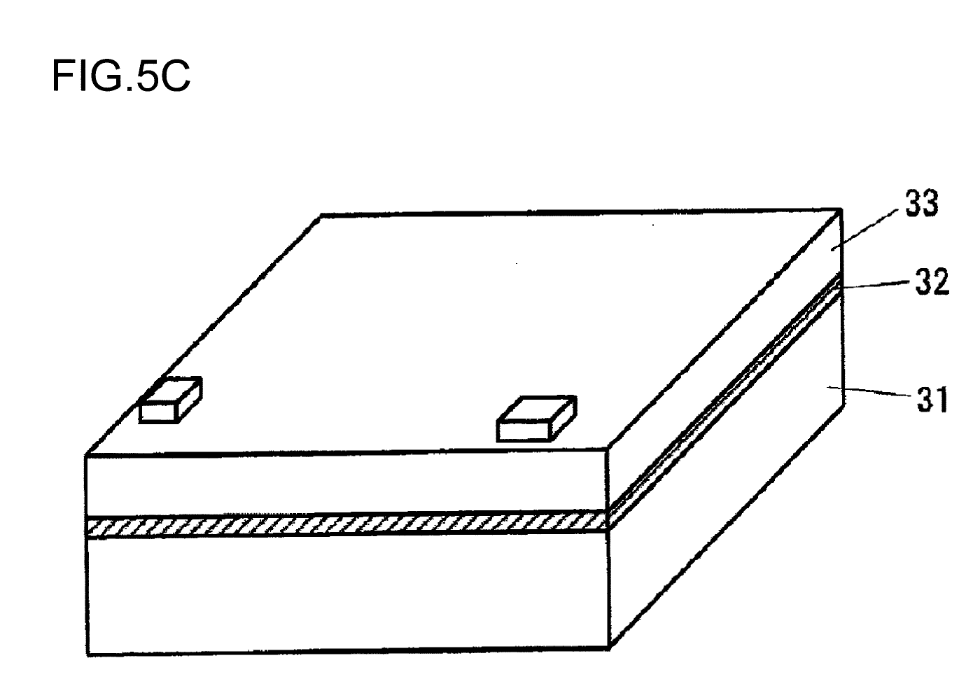

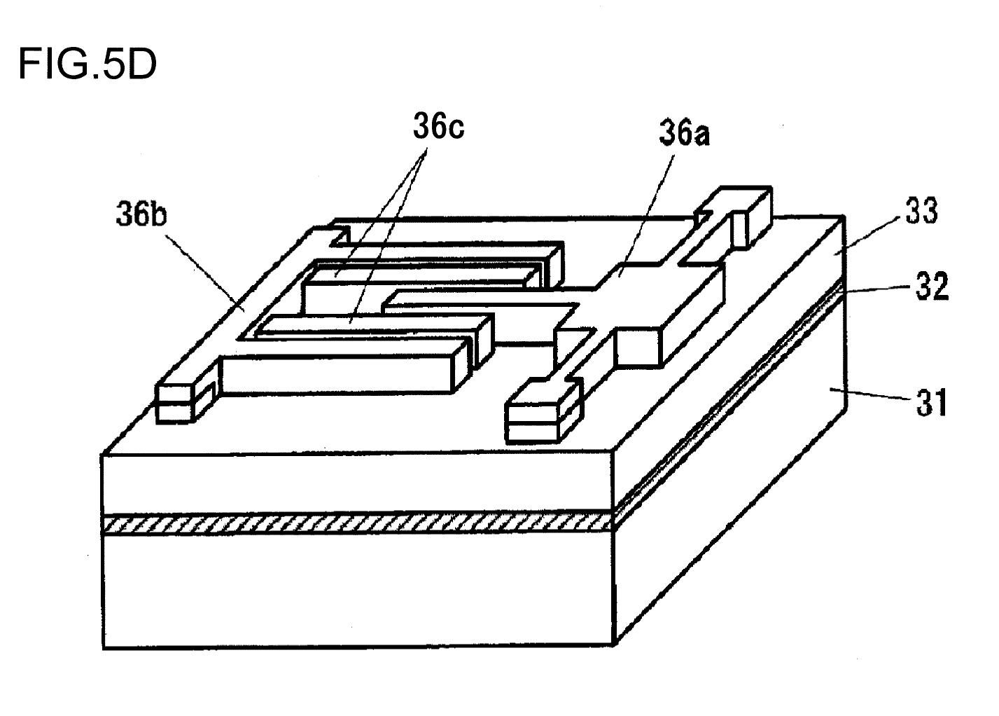

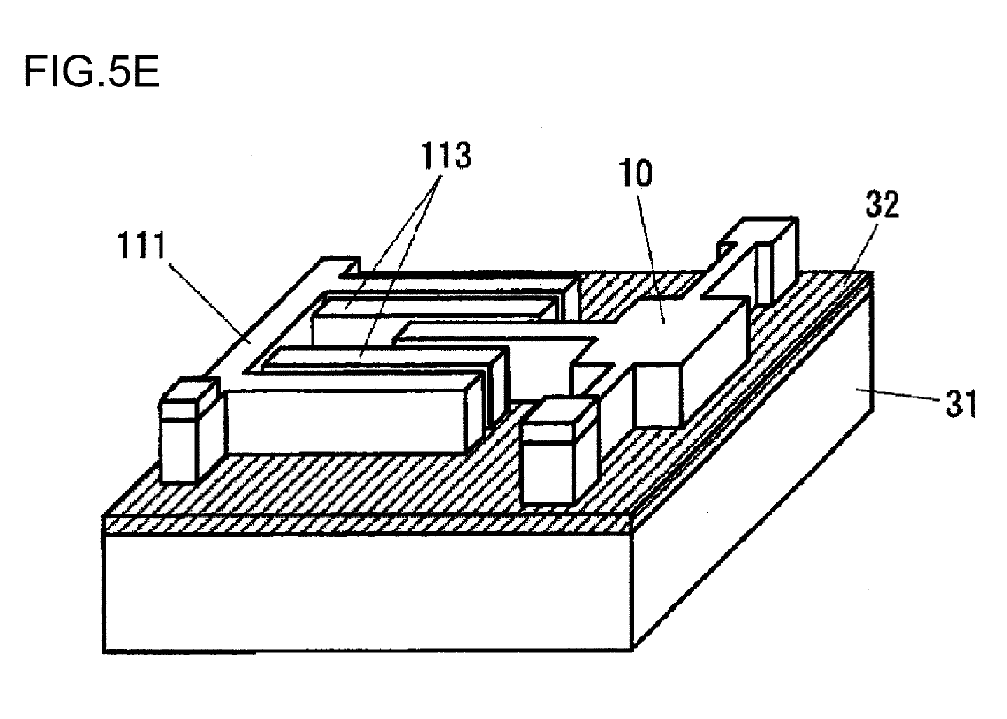

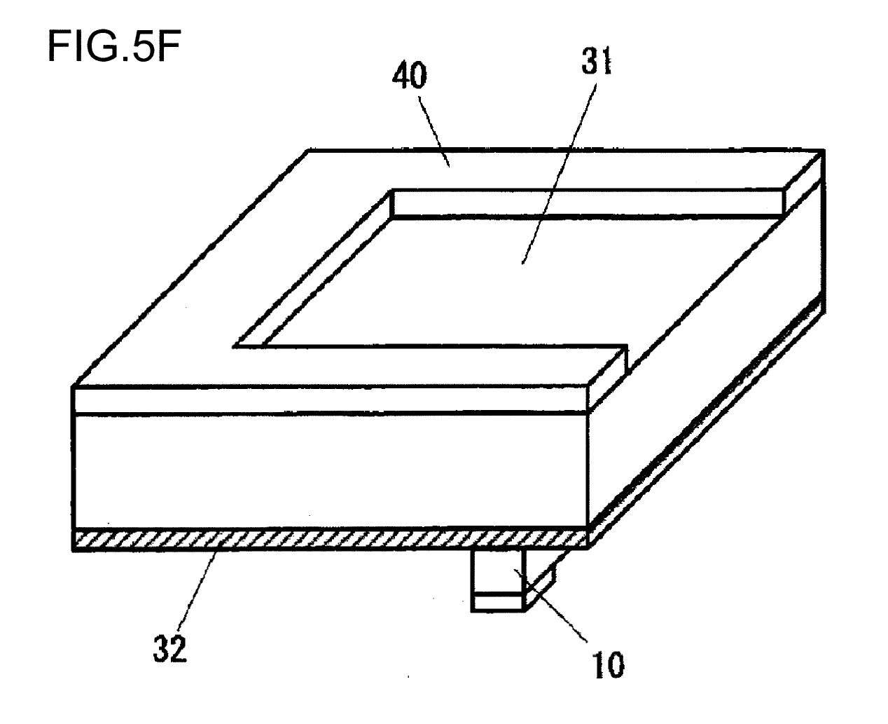

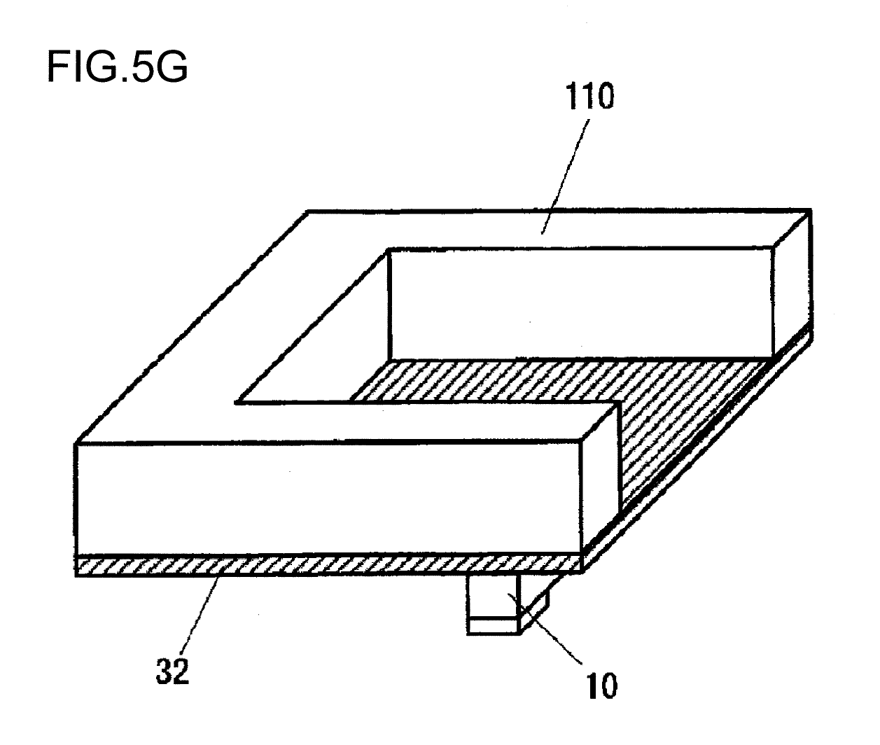

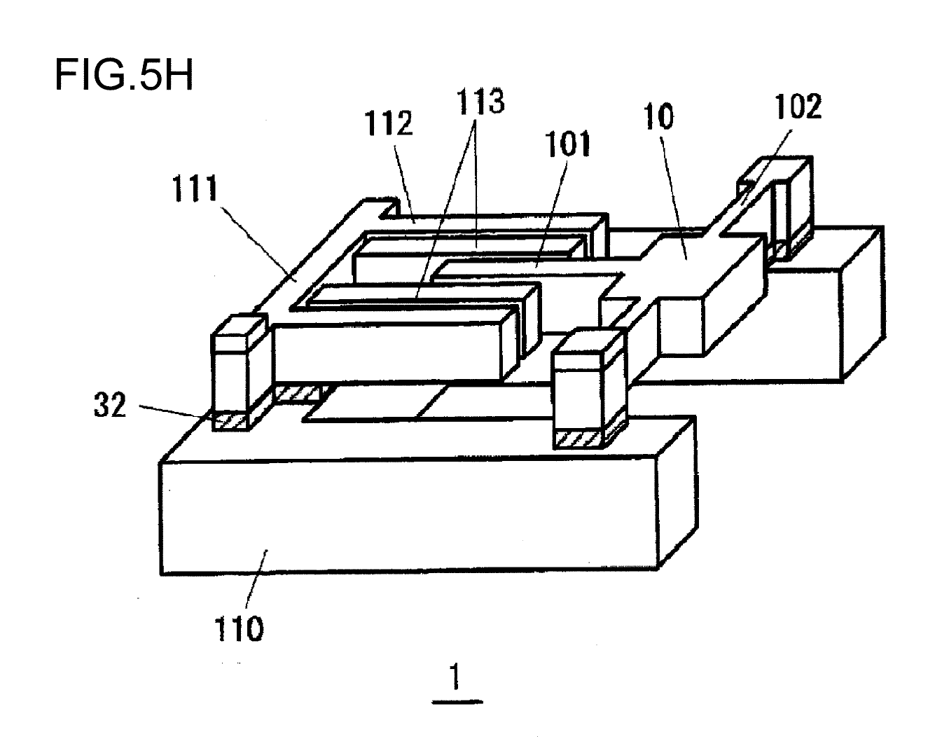

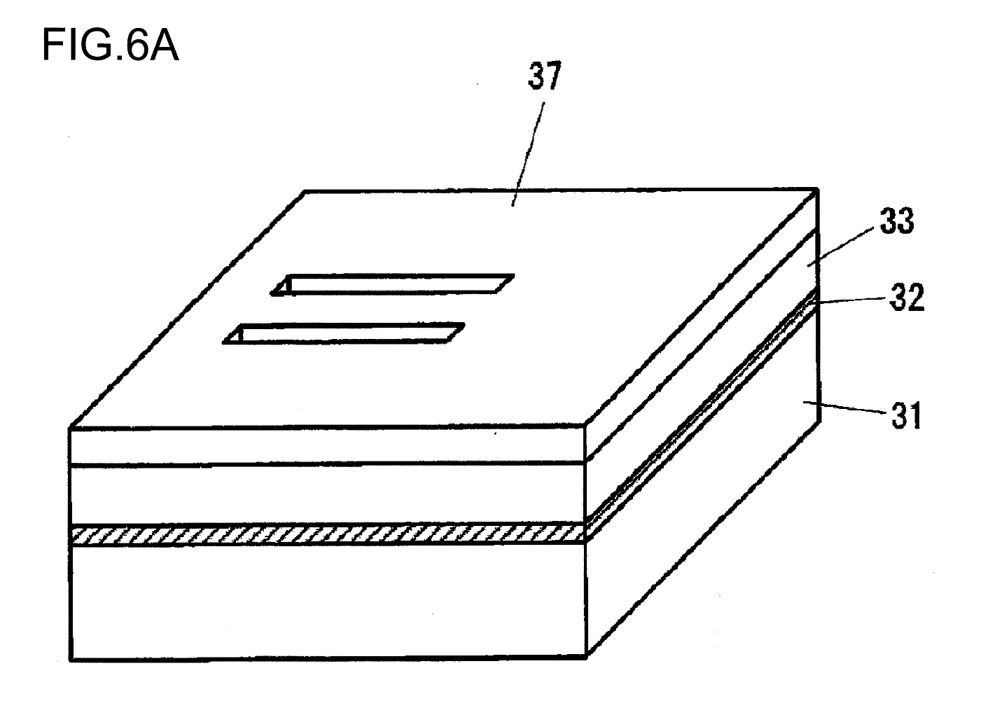

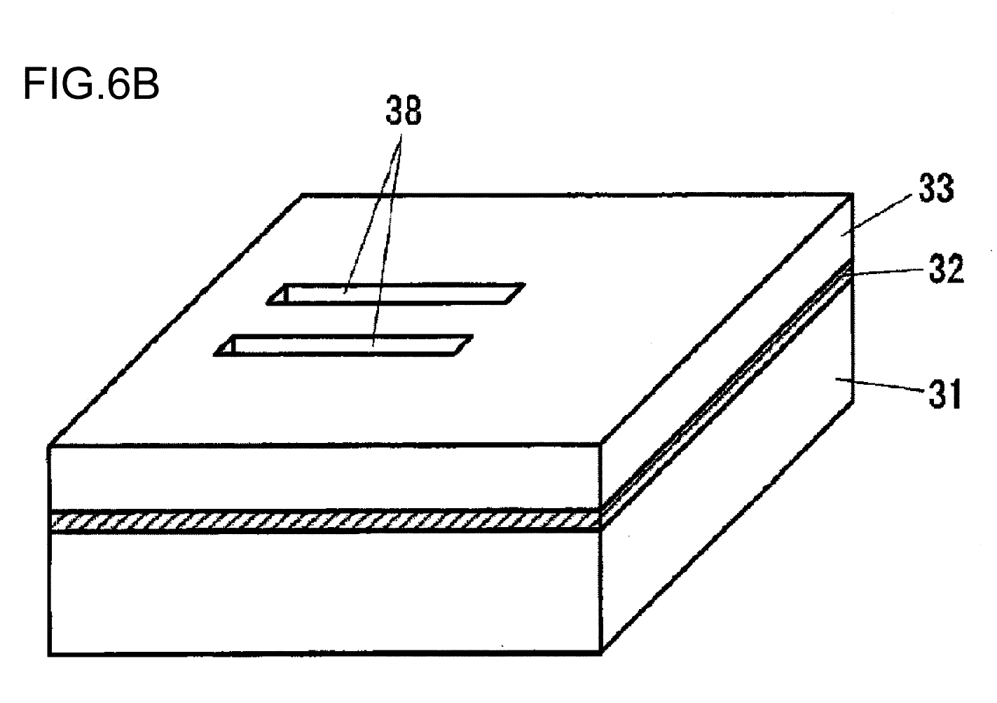

Referring to FIGS. 5A to 5H, and FIGS. 6A and 6B, the manufacturing method for the electrostatic induced type electromechanical transducer 1 is explained. The electrostatic induced type electromechanical transducer 1 that is shown in FIG. 1 is integrally formed by a semiconductor microprocessing technique using, for instance, a silicon-on-insulator (SOI) substrate. The SOI substrate, which includes an upper Si layer 33, a SiO₂ layer 32 and a lower Si layer 31, is fabricated by forming a SiO₂ layer on one of two Si monocrystalline substrates and bonding the two Si monocrystalline substrates to each other so as to sandwich the SiO₂ layer. A portion of the Si substrate on which an electrode pad is supposed to be formed may be doped as appropriate before use to provide increased adhesion to metal or improved electroconductivity. In the present invention, the doping may be either of a P type or of an N type.

In the first step that is shown in FIG. 5A, a nitride film (Si₃N₄) 34 is formed on the Si layer 33 using photolithography. In the second step that is shown in FIG. 5B, a resist is coated on the nitride layer 34 and then resist patterns 35A and 35B for forming connection electrodes to connect the movable comb teeth electrode 101 and the fixed comb teeth electrode 112 to each other are formed by photolithography. Thereafter, in the third step, the front surface of the substrate is etched using RIE or the like (for instance, ICP-RIE) to remove the nitride film 34 on a part other than the portion on which the resist patterns 35A and 35B are formed (FIG. 5C).

In the fourth step that is shown in FIG. 5D, a resist is coated on the substrate that is shown in FIG. 5C and resist patterns 36a, 36b, and 36c for forming the movable comb tooth electrode 101, the fixed comb tooth electrode 112, and the isolated comb tooth 113, respectively, are formed on the coated substrate by using photolithography.

In the fifth step, the Si layer 33 is etched using RIE or the like and thereafter, the resist patterns 36a, 36b, and 36c are removed. As a result, the movable part 10, the fixed electrode 111 and the isolated comb teeth 113 are formed on the SiO₂ layer 32.

In the sixth step that is shown in FIG. 5F, a resist pattern 40 for forming a base is formed on a backside of the substrate, that is, a Si layer 31. Then, in the seventh step that is shown in FIG. 5G, the Si layer 31 is etched using RIE or the like to form the base 110. Thereafter, the exposed SiO₂ layer 32 is etched with a buffered hydrogen fluoride solution to finish the electrostatic induced type electromechanical transducer 1 as shown in FIG. 5H. The isolated comb teeth 113 of the electrostatic induced type electromechanical transducer 1 obtained are made of the Si layer 33 of the SOI substrate.

In the electrostatic induced type electromechanical transducer 1 that is shown in FIG. 5H, the isolated comb tooth 113 is made of silicon. However, it may be made of a material other than silicon (i.e., a material that has a dielectric constant greater than 1). For instance, the isolated comb teeth 113 may be made of a resist material as described below.

In this case, a resist pattern 37 is formed on the Si layer 33 as shown in FIG. 6A. Then, the Si layer 33 is etched to form holes 38 for forming the isolated comb teeth 113 (FIG. 6B). By filling the holes 38 with a resist material, the isolated comb teeth 113 made of the resist material is formed in advance. Thereafter, the movable part 10 and the fixed electrode 111 are formed by the process as described above.

### FIRST EXAMPLE

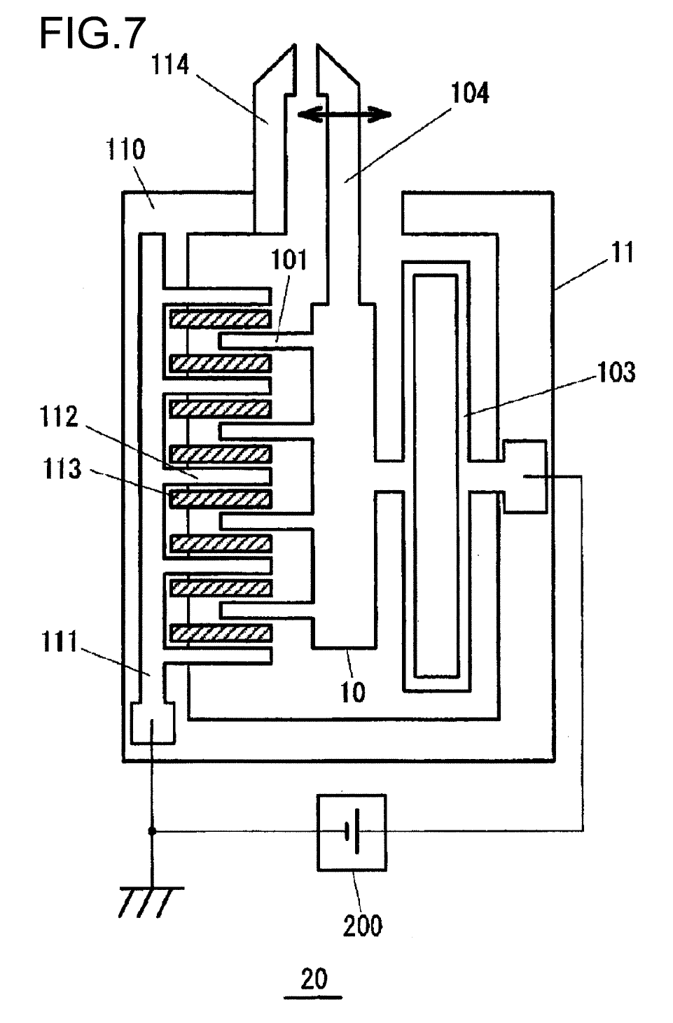

FIG. 7 is a diagram showing a first example using the electrostatic induced type electromechanical transducer shown in FIG. 1, showing an outline arrangement of the nano tweezers 20. Components that are the same as or similar to those shown in FIG. 1 are designated by the same reference signs as those shown in FIG. 1. The nano tweezers 20 include grippers 104 and 114 formed at the fixed part 11. By driving one of the grippers 104, a sample is gripped between the gripper 114 formed at the fixed part 11 and the gripper 104 formed at the movable part 10.

The gripper 104 is formed at the movable part 10 and driven by a comb tooth actuator constituted by the electrostatic induced type electromechanical transducer to open and close. The comb tooth actuator includes the fixed electrode 111 at which a plurality of comb tooth electrodes 112 is formed, the movable part 10 at which a plurality of comb tooth electrodes 101 is formed, a resilient support 103 that resiliently supports the movable part 10 on the base 110, and a plurality of isolated comb teeth 113. Application of voltage between the movable part 10 and the fixed electrode 111 by a drive control unit 200 enables the movable part 10 to move horizontally in the drawing.

In the present example, each of the isolated comb teeth 113 having a dielectric constant greater than 1 is arranged between the comb tooth electrodes 101 and 112. This enables the voltage necessary for obtaining a desired gripping force to be decreased. If the applied voltage is too high, the isolated comb tooth 113 that is present between the comb tooth electrodes 101 and 112 eliminates the occurrence of pull-in (fixed state) of the comb tooth electrode 101 on the movable side and the comb tooth electrode 112 on the fixed side.

In the example that is shown in FIG. 7, one of the grippers 114 is fixed and the other of the grippers 104 is movable. However, the gripper 114 may be provided with a comb tooth actuator similar to that provided at the gripper 104 to make the gripper 114 movable.

### SECOND EXAMPLE

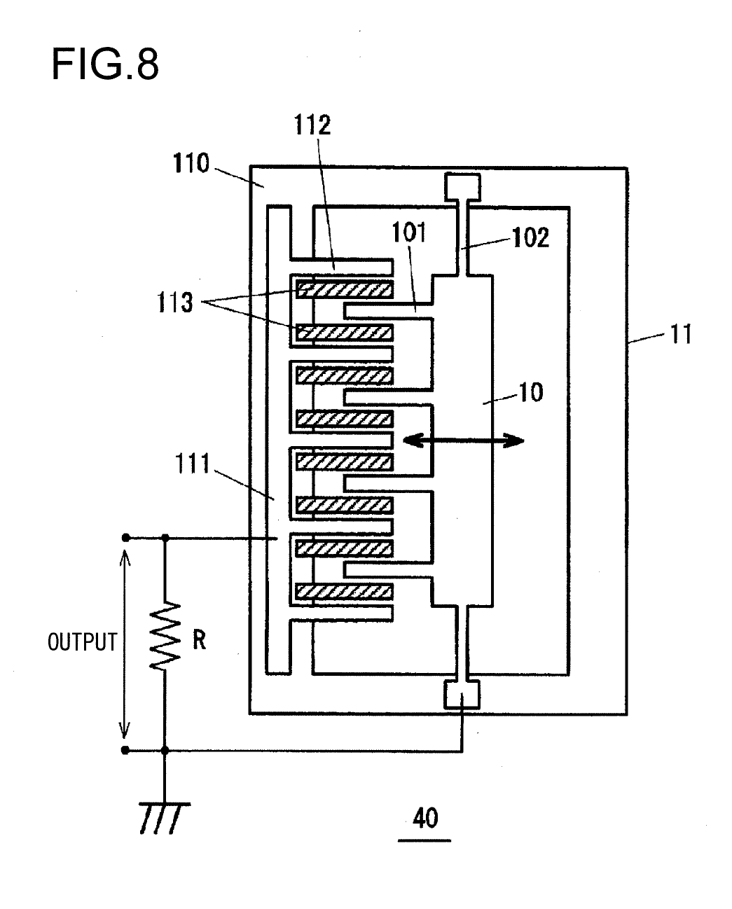

FIG. 8 is a diagram showing a second example using the electrostatic induced type electromechanical transducer of a comb tooth structure shown in FIG. 1, showing an outline arrangement of the vibration-driven power generation element 40. Components that are the same or similar to those that are shown in FIG. 1 are designated by the same reference signs as those shown in FIG. 1. In the vibration-driven power generation element 40 that is shown in FIG. 8, the fixed electrode 111 is grounded through an output resistance R. The comb tooth electrode 101 of the movable part 10 is maintained at a higher potential or a lower potential than the comb tooth electrode 112 of the fixed electrode 111. A bias voltage may be applied to the comb tooth electrode 101 by, for instance, a method of using an external voltage source or using an electret. In the example that is shown in FIG. 8, an electret that is positively charged is formed at the comb tooth electrode 101 to provide an arrangement that enables the comb tooth electrode 101 to be maintained at a higher potential.

When the movable part 10 vibrates in the horizontal direction in the drawing, the amount of insertion of the comb tooth electrode 101 between the comb tooth electrodes 112 changes, which in turn changes the electrostatic capacitance at the comb tooth electrodes 101 and 112 as described above. As the electrostatic capacitance changes, current flows in the output resistance R to generate voltage across the output resistance R. The isolated comb tooth 113 having a dielectric constant greater than 1 arranged between the comb tooth electrodes 101 and 112 enables the capacitor to have increased electrostatic capacitance and an increased change in electrostatic capacitance. This enables the power generation element to have an increased output level.

(Method for Forming an Electret)

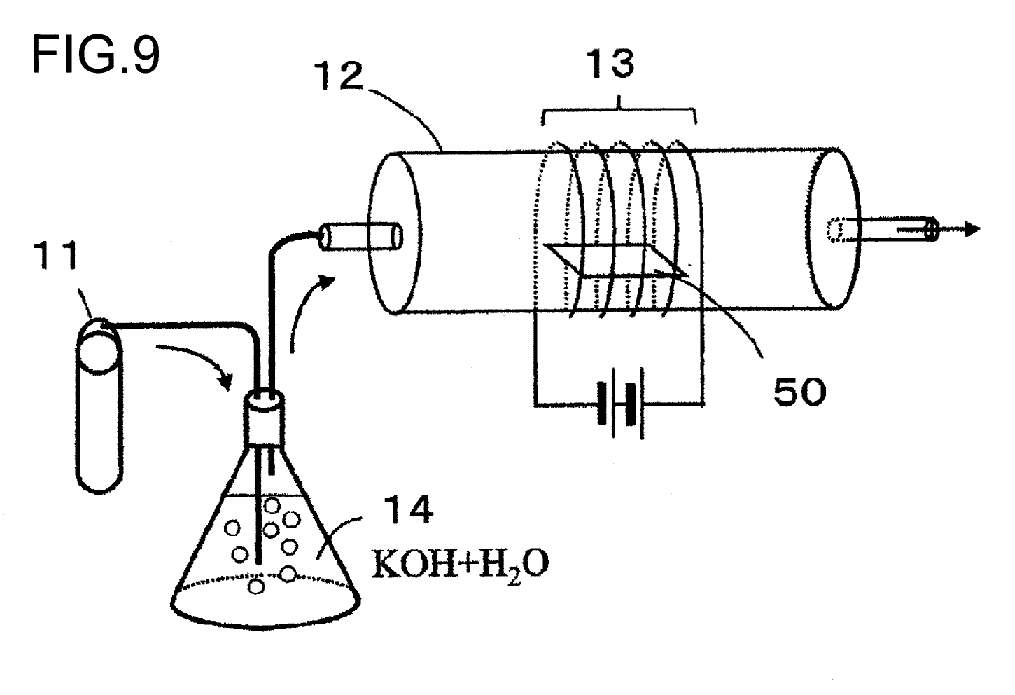

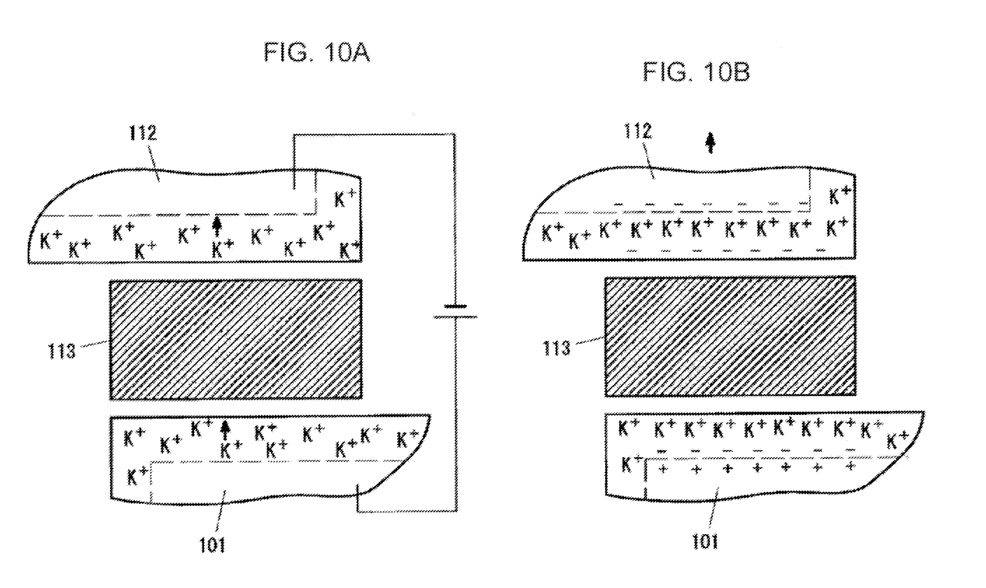

As the method for forming an electret at the comb tooth electrode 101 may be used the method described in, for instance, JP 2013-13256 A (bias-temperature method; B-T method). FIG. 9 and FIG. 10 are diagrams each illustrating a method for forming an electret layer on the comb tooth electrode 101. In the present embodiment, a silicon oxide film (SiO₂) containing K⁻ ions, which is formed on the surfaces of the movable part 10 and the fixed electrode 111, each being made of the Si layer 33, is charged to form an electret before use. Here, explanation is made on the assumption that the isolated comb tooth 113 is made of Si or silicon oxide film (SiO₂).

In FIG. 9, a sample 50 is a substrate on which the electrostatic induced type electromechanical transducer 1 is formed. An oxidation oven 12 in which the sample 50 is placed is supplied with nitrogen gas containing vapor of KOH aqueous solution. The nitrogen gas that contains the vapor of the KOH aqueous solution is obtained by warming an aqueous KOH solution 14 having dissolved KOH in deionized water in a hot bath, into which nitrogen gas (carrier gas) 11 is bubbled. If the sample 50 is heated with a heater 13, silicon is thermally oxidized to form a SiO₂ layer containing K⁺ ions on the surfaces of the Si layers 31 and 33.

Subsequently, to positively charge the SiO₂ layer formed on the movable part 10, voltage is applied between the movable part 10 and the fixed electrode 111 while the sample 50 is being heated at a high temperature. FIG. 10 is a diagram illustrating a charging process, schematically showing the comb tooth electrodes 101 and 112. The example that is shown in FIG. 10 is an example in which the electret of the comb tooth electrode 101 is positively charged. In this example, the comb tooth electrode 101 side is the higher potential side.

In the vicinity of the surface of the comb tooth electrodes 101 and 112 made of the Si layer 33 are formed SiO₂ layers 111a and 112a each containing K⁺ ions. K⁺ ions distribute all over the SiO₂ layers 111a and 112a. In this condition, applying voltage as shown in FIG. 10 while heating causes force to be exerted to K⁺ ions to cause K⁺ ions to migrate along the direction of the electric field. As a result, at the SiO₂ layer 111a of the comb tooth electrode 101, K⁺ ions distribute in the vicinity of the surface to make the electrode positive. On the contrary, in the case of the comb tooth electrode 112, a portion of the SiO₂ layer 112a in the vicinity of the surface is negatively charged.

In the example that is shown in FIG. 10, the isolated comb tooth 113 is formed of, for instance, resist. However, it may be formed of the Si layer 33. In this case, also on the surface of the isolated comb tooth 113 is formed a SiO₂ layer containing K⁺ ions.

In the examples described above, explanation is made on the example in which K⁺ ions are used as the ions for forming the electret film. However, the electret structure according to the present invention can be formed by using positive ions other than the K⁺ ions. In particular, use of alkali ions that have a relatively large ion radius decreases ion migration in the formed electret film after the electret formation and hence enables the formed electret film to have a relatively longer period of time of maintaining the surface potential. In the wet oxidation described above, an aqueous solution containing alkali ions other than the K⁺ ions is used instead of the aqueous potassium hydroxide solution.

### THIRD EXAMPLE

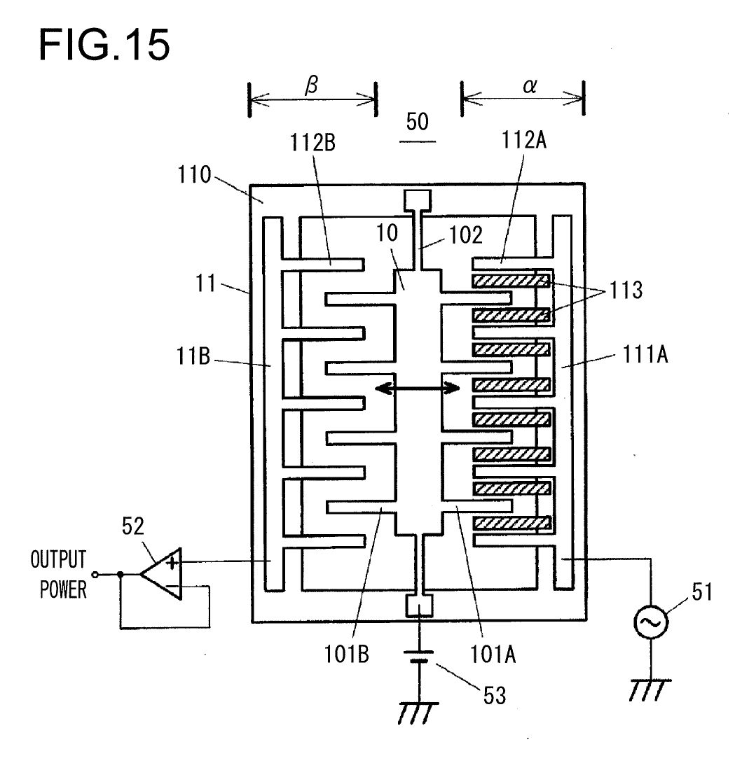

FIG. 15 is a diagram illustrating a third example using an electrostatic induced type electromechanical transducer as shown n FIG. 1, showing an outline arrangement of a booster circuit 50. The booster circuit 50 includes a pair of fixed electrodes 111B and 111A on the lateral sides of the movable part 10 to sandwich it. On the left side of the movable part 10, a plurality of comb tooth electrodes 101B is formed meshed with the comb tooth electrodes 112B. On the right side of the movable part 10 is formed of a plurality of comb tooth electrodes 101A meshed with the comb tooth electrodes 112A. The booster circuit 50 shown in FIG. 15 includes a three-terminal-type comb tooth actuator that constitutes two comb tooth actuators a and 0 that share the movable part 10.

Between the fixed electrode 111A on the input side and the ground is connected to an alternating current source 51 that applies a resonance frequency component of the three-terminal-type comb tooth actuator. Between the movable part 10 and the ground is connected to a direct current source 53 that generates Coulomb force between the comb tooth electrodes. The direct current source 53 includes a direct current source circuit that generates fixed direct current voltage and other direct current voltage generating sources such as electrets. Boosted output is taken out from the fixed electrode 111B on the output side via a voltage follower 52.

In the booster circuit 50 shown in FIG. 15, when direct current voltage is applied to the movable part 10, the comb tooth actuators α and β can be regarded as separate capacitors. Application of alternating voltage of resonance frequency to the fixed electrode 111A enables the movable part 10 to oscillate to effect switching of capacitance (charging/discharging). The alternating current source may be omitted by incorporating the three-terminal-type comb tooth actuator according to the present embodiment into a feedback circuit in the self-excited oscillator circuit system.

The output terminal of the voltage follower 52 outputs alternating voltage having an amplitude, the value of which exceeds the value of amplitude of the input alternating current voltage. Rectifying this alternating current voltage (not shown) provides direct current. The direct current voltage thus obtained can have a value that exceeds the value of the input direct current voltage by setting circuit conditions as appropriate.

In this manner, the function of booster circuit is achieved. However, charges from a permanently charged membrane such as an electret may also be used for applying direct current voltage. In particular, use of electrets enables the direct current voltage to have a considerably high value (for instance, a direct current voltage of 100V or more) and thus enables direct current voltage finally obtained to have an increased value as high as several ten volts to several hundred volts. In addition, use of considerably high Q values provided by micro-electro-mechanical systems (MEMS) enables the booster circuit to operate with high efficiency.

In the examples 1 to 3 above, the electrostatic induced type electromechanical transducer 1 shown in FIG. 1 is used to constitute nano tweezers and vibration-driven power generation elements. However, the electrostatic induced type electromechanical transducer 1 is not limited to the one having the arrangement shown in FIG. 1 and the electrostatic induced type electromechanical transducers 1 having the arrangements according to the following variation examples may also be used.

(Electrostatic Induced Type Electromechanical Transducer 1 According to Variation Example 1)

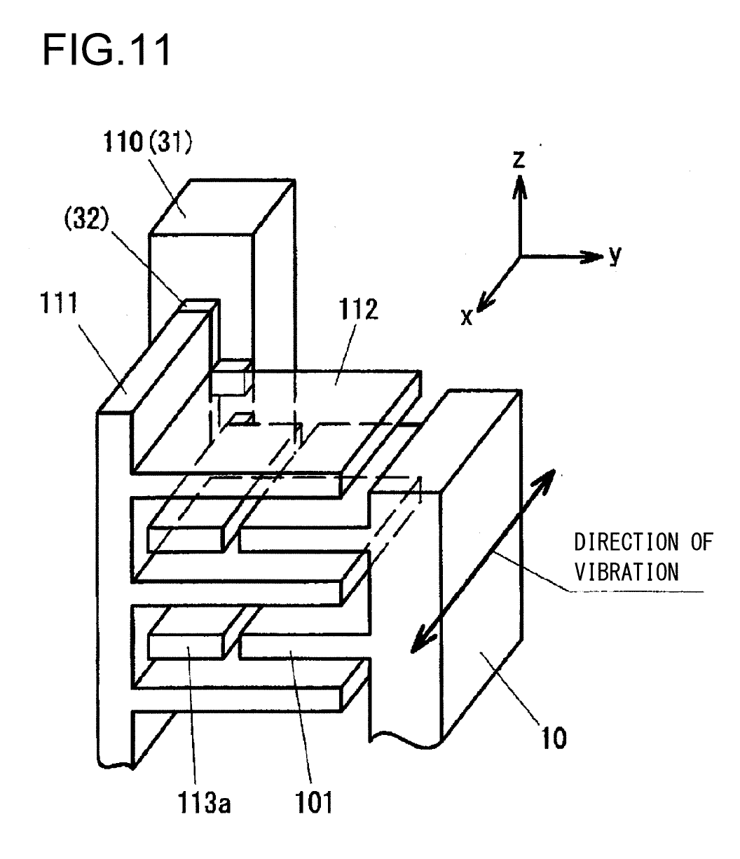

FIG. 11 is a diagram showing the electrostatic induced type electromechanical transducer 1 according to a first variation example. Constituent components that are the same as or similar to those of the electrostatic induced type electromechanical transducer 1 that is shown in FIG. 1 are designated by the same reference signs as those that are shown in FIG. 1. FIG. 11 is a perspective view showing the three-dimensional shapes of the movable part 10, the comb tooth electrodes 101 and 112, the base 110, the fixed electrodes 111, and the isolated comb teeth 113a of the electrostatic induced type electromechanical transducer 1.

In the electrostatic induced type electromechanical transducer 1 shown in FIG. 11, the movable part 10 is resiliently-supported to allow movement in the x direction. Consequently, the comb tooth electrode 101 translates in the x direction with respect to the comb tooth electrode 112. The isolated comb teeth 113a correspond to the isolated comb teeth 113 in FIG. 1 and are made of a material having a dielectric constant greater than 1. In the arrangement shown in FIG. 1, the isolated comb teeth 113 are each disposed between the comb tooth electrodes 101 and 112. In contrast, the isolated comb teeth 113a in FIG. 11 are each disposed so as to oppose a front edge of each of the comb tooth electrodes 101. As a result, the line of electric force that comes out from the front edge of each of the comb tooth electrodes 101 enters each of the comb tooth electrode 112 through each of the isolated comb teeth 113a. This enables the electrostatic capacitance and the change in electrostatic capacitance to increase as compared with the arrangement shown in FIG. 2 in which no isolated comb tooth 113a is provided.

(Electrostatic Induced Type Electromechanical Transducer 1 According to Variation Example 2)

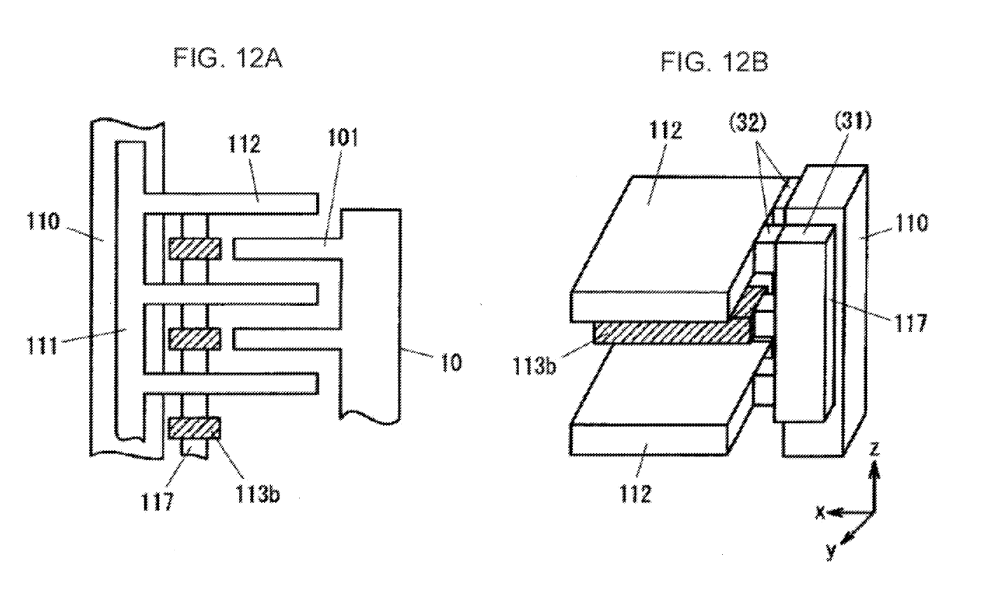

FIG. 12 is a diagram showing the electrostatic induced type electromechanical transducer 1 according to a second variation example. Constituent components that are the same as or similar to those of the electrostatic induced type electromechanical transducer 1 that are shown in FIG. 1 are designated by the same reference signs as those shown in FIG. 1. FIG. 12(a) is a front elevation showing the movable part 10, the comb tooth electrodes 101 and 112, the base 110, the fixed electrode 111, and the isolated comb teeth 113b of the electrostatic induced type electromechanical transducer 1. On the other hand, FIG. 12(b) is a perspective view as seen from the backside showing the comb tooth electrodes 112, the base 110, the fixed electrode 111, and the isolated comb tooth 113b of the electrostatic induced type electromechanical transducer 1.

Also in the example that is shown in FIG. 12, in the same manner as that in the example that is shown in FIG. 11, the movable part 10 is resiliently supported, allowing its movement in the x direction. This enables the comb tooth electrodes 101 to translate in the x direction with respect to the comb tooth electrodes 112. The isolated comb teeth 113b, which corresponds to the isolated comb teeth 113a in FIG. 11, are fixed to the comb tooth electrodes 112 via a support 117. The support 117 is formed simultaneously with the formation of the base 110 by etching in the steps that are shown in FIG. 5F and FIG. 5G. The support 117 includes the Si layer 31 and the SiO₂ layer 32. The Si layer 31 is connected to the comb tooth electrodes 112 and the isolated comb teeth 113b via the SiO₂ layer 32, which is an electric insulator. Consequently, the comb tooth electrodes 112 and the isolated comb teeth 113b are electrically insulted from each other. If the isolated comb teeth 113b themselves have sufficient insulating properties (equal to or more than 100 MΩcm), they may be connected to the comb tooth electrodes 112 via a Si material or the like.

(Electrostatic-Induced-Type Electromechanical Transducer 1 According to Variation Example 3)

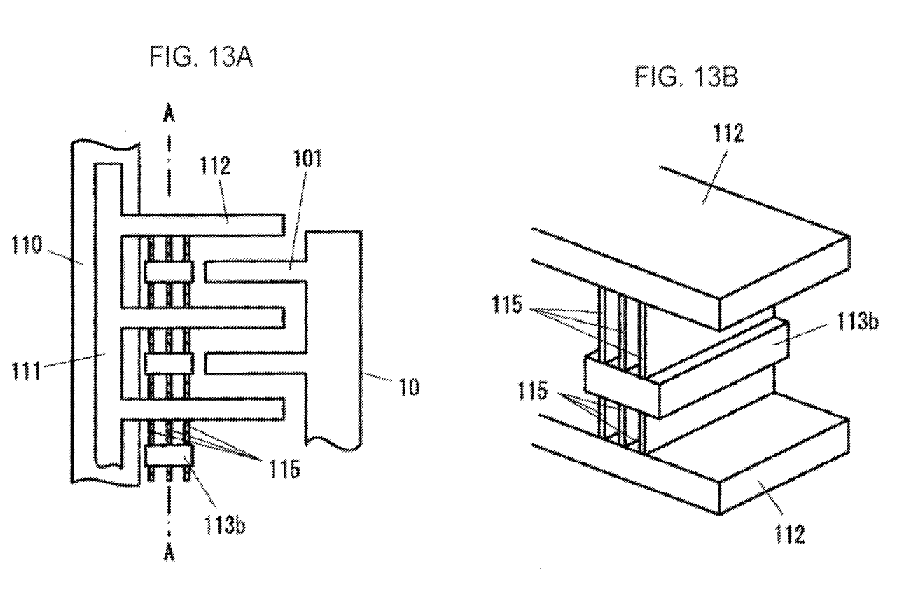

FIG. 13 is a diagram showing the electrostatic induced type electromechanical transducer 1 according to a third variation example. The third variation example is a further modification of the second variation example that is shown in FIG. 12. In this modification, the isolated comb teeth 113b are supported by a plurality of beams 115. FIG. 13(b) is a perspective view of a portion at which the beams 115 are formed. The beams 115 are each a considerably thin plate-like member that is rectangular in cross-section having a size in thickness of, for instance, 1 μm or less. The beams 115 are formed from the Si layer 33 of the SOI substrate simultaneously with the formation of the comb tooth electrodes 112 and the isolated comb teeth 113b.

The beams 115, which are considerably thin, in whole are thermally oxidized to provide electrically insulating SiO₂ when the Si layer 33 is thermally oxidized in order to form electrets at the comb tooth electrodes 101. As a result, the comb tooth electrodes 112 and the isolated comb teeth 113b are electrically insulated from each other.

(Electrostatic Induced Type Electromechanical Transducer 1 According to Variation Example 4)

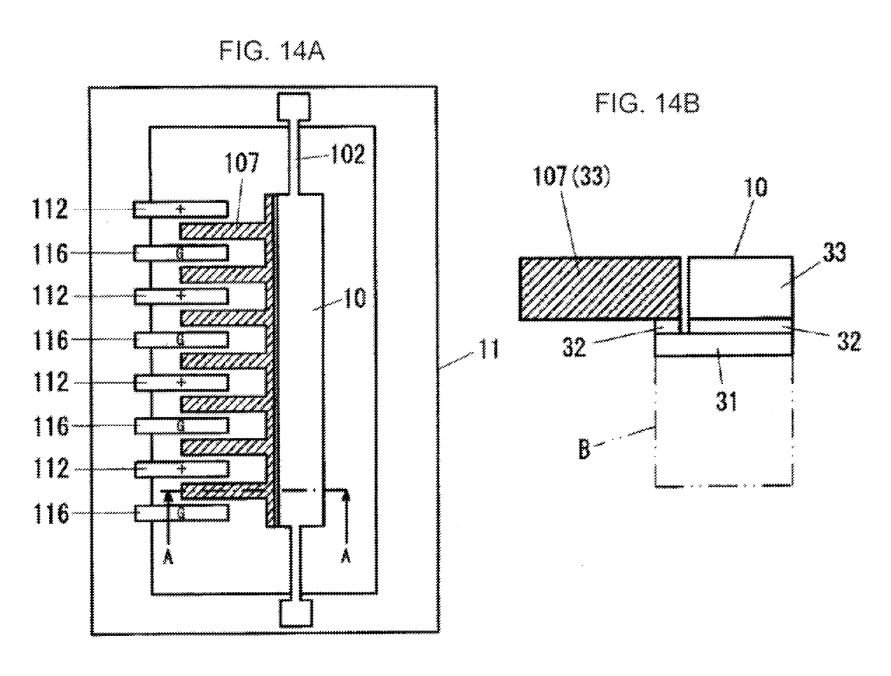

FIG. 14 is a diagram showing the electrostatic induced type electromechanical transducer 1 according to a fourth variation example. FIG. 14(a) is a plan view showing the electrostatic induced type electromechanical transducer 1 and FIG. 14(b) is a cross-sectional view along the line A-A of FIG. 14(a). In the electrostatic induced type electromechanical transducers 1 that are shown in FIG. 1 and FIGS. 11 to 13, comb tooth electrodes are provided on each of the movable side and the fixed side and between any two adjacent ones of these comb tooth electrodes is disposed an isolated comb tooth made of a material having a relative dielectric constant greater than 1.

On the other hand, the electrostatic induced type electromechanical transducer 1 that is shown in FIG. 14 is provided with both the comb tooth electrodes 112 and 116 on the fixed side and with the comb teeth 107 formed at the movable part 10 that is electrically insulated. If the movable part 10 is vibrated in the horizontal direction in the figure, the amount of insertion of the comb tooth 107 between the comb tooth electrodes 112 and 116 is changed to vary the electrostatic capacitance. This corresponds to the model shown in FIG. 4(c).

As shown in the cross-sectional view along the line A-A in FIG. 14(b), the fixed part 10 includes the Si layer 33, the SiO₂ layer 32, and the Si layer 31 of the SOI substrate. The part of the Si layer 31 that is indicated in chain double-dashed line is removed by etching. The comb teeth 107 are formed on the Si layer 31 via the SiO₂ layer 32. For instance, the comb tooth electrodes 116 are set to the ground potential and the comb tooth electrodes 112 is set at a positive potential. Upon use of the electrostatic induced type electromechanical transducer 1 shown in FIG. 14 as an actuator, the potential of the comb tooth electrodes 112 is varied to vary the amount of insertion of the comb teeth 107. In case the electrostatic induced type electromechanical transducer 1 is used as the vibration-driven power generation element, respective electrets are formed on the comb tooth electrodes 112 and set at a positive potential.

According to the arrangement shown in FIG. 14, the transducer 1 is configured to move the comb teeth 107 having a sufficiently high relative dielectric constant in the gap between the comb tooth electrodes 112 and 116 to provide a variation in electrostatic capacitance. While it is necessary to set the relative dielectric constant of the comb tooth 107 to a considerably high level to increase the change in capacitance, this structure allows application of high voltage and enables formation of high performance electrets.

As explained above, the electrostatic induced type electromechanical transducer 1 according to the present invention as shown in FIG. 1 includes a fixed electrode 111 having a plurality of comb tooth electrodes 112, a second electrode (movable part 10) having a plurality of comb tooth electrodes 101 disposed meshed with the plurality of comb tooth electrodes 112 through respective gaps, and a plurality of dielectric members (isolated comb teeth 113) disposed in an electric field formation space between the comb tooth electrodes 112 and the comb tooth electrodes 101 and made of a material having a relative dielectric constant greater than 1, wherein the fixed electrodes 111 and the isolated comb tooth electrodes 113 are fixedly supported on the base 110 and the movable part 10 at which the comb tooth electrode 101 is formed is movably supported on the base 110.

As described above, disposition of the dielectric members having a relative dielectric constant greater than 1 in the gaps between the comb tooth electrodes 101 and 112 enables the electrostatic induced type electromechanical transducer to have more increased electrostatic capacitance and more increased changes in electrostatic capacitance upon changes in the overlapping area between the comb tooth electrodes 101 and 112.

Comb teeth in the MEMS technology are of microfine structures and formation of a dielectric membrane on the surface of the comb teeth causes the comb teeth to warp. This problem is eliminated by disposing the dielectric member in the electric field formation space between the comb tooth electrodes (for instance, a structure of isolated disposition or a structure formed by filling) as described above. The structure of disposition of the dielectric members may be achieved by disposing the dielectric members in the electric field formation space between the comb tooth electrodes 101 and 112 as shown in FIG. 1 or disposing the dielectric members in the electric field formation space on the front edge side of the comb tooth electrodes 101 so that the dielectric members oppose the front edges of the comb tooth electrodes 101 through respective gaps as shown in FIG. 11.

Use of the techniques according to this embodiment enables formation of an electret-type electrostatic actuator having increased electrostatic capacitance or formation of electret-type electrostatic actuator having an electric field at higher voltage using process rules equivalent to those conventionally used. Use of the techniques according to this embodiment also enables formation of an electret-type electrostatic actuator capable of providing high output without application of high voltage, for instance, by decreasing spacing between the comb teeth. Alternatively, if the gap is increased to some extent, no substantial loss of capacitance results, which enables higher voltage to be applied accordingly. Use of the techniques according to this embodiment also enables the electrostatic type electromechanical transducer of an external bias voltage type without electret, which results an increased change in capacitance and an increased S/N ratio or an increased output level.

The example that is shown in FIG. 1 adopts a configuration in which the second comb tooth electrodes are moved with respect to the first comb tooth electrodes and the dielectric members, which are fixed to the base. However, another configuration may be adopted in which the second comb tooth electrodes are provided on the fixed side, toward which the first comb tooth electrodes and the dielectric members on the movable part side are moved. The example that is shown in FIG. 14 adopts a configuration in which the dielectric member is moved with respect to a pair of comb tooth electrodes provided on the fixed side. However, another configuration may be adopted in which the dielectric member is provided on the fixed side, toward which the pair of comb tooth electrodes is moved.

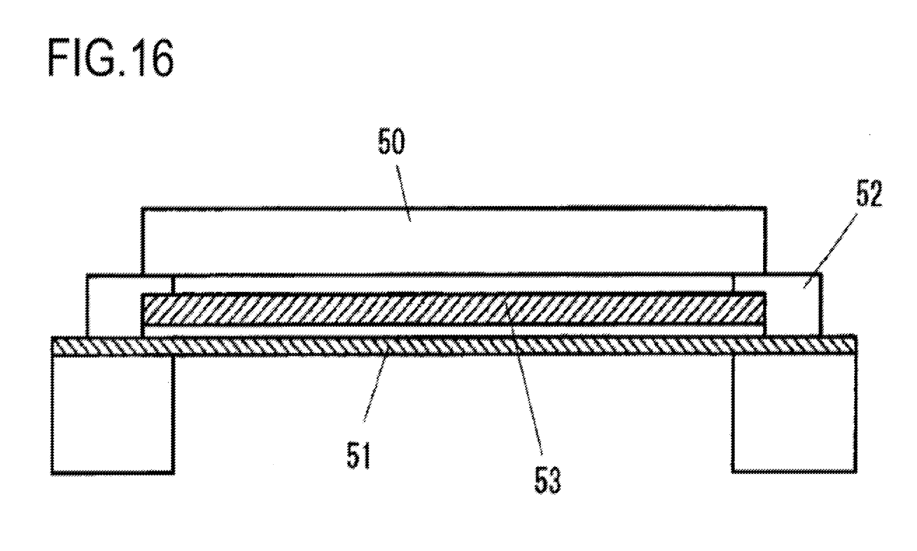

In the above mentioned embodiments, explanations are made taking the comb tooth structure as an example. However, the electrostatic actuator used in the present invention is not limited to the one having a comb tooth structure and the present invention may be adopted in a thin-film type electrostatic actuator as shown in FIG. 16. FIG. 16 is a diagram showing an outline arrangement of a capacitor-type microphone, which includes a movable thin film 51 and a back plate 50. In a gap space between the movable thin film 51 and the back plate 50 is disposed a dielectric plate 53 having a relative dielectric constant greater than 1 through a gap. The back plate 50 is set at the ground potential and the movable thin film 51 is set at a positive potential. The dielectric plate 53 is electrically insulated from the movable thin film 51 and the back plate 50 by the insulating layer 52.

If acoustic wave is input from below in the figure, the movable thin film vibrates due to acoustic pressure to change the electrostatic capacitance. The microphone shown in FIG. 16, which includes the dielectric plate 53, has increased electrostatic capacitance and an increased change in electrostatic capacitance and provides an increased output. The dielectric plate 53 itself may be charged and thus it is desirable to provide, for instance, dimples to eliminate sticking on the surface of the dielectric plate 53. Also, an electro conductor may be formed on the surface of the dielectric body to let charges out as necessary. Another insulating layer may be provided on the opposite electrode side of the dielectric plate 53.

The embodiments described above may be used singly or in any combinations. This enables the advantageous effects conferred by the embodiments to be exhibited singly or in synergism. The present invention is not limited to the above-described embodiments and various modifications may be made without damaging the features of the present invention.

The disclosure of the following priority application is incorporated herein by reference:

Japanese Patent Application No. 2013-108275 (filed May 22, 2013)

### REFERENCE SIGNS LIST

1, 100: electrostatic induction type electromechanical transducer, 10: movable part, 11: fixed part, 20: nano tweezers, 40: vibration-driven power generation element, 50: booster circuit, 101, 112, 112A, 112B, 116: comb tooth electrodes, 104, 114: gripper, 110: base, 111, 111A, 111B: fixed electrode, 113, 113a, 113b: isolated comb teeth, 200: drive control unit

1. An electrostatic induced type electromechanical transducer comprising:
a first electrode having a plurality of first comb tooth electrodes;
a second electrode having a plurality of second comb tooth electrodes arranged meshed with the plurality of first comb tooth electrodes through respective gaps;
a plurality of dielectric members at an electric field formation space between the first comb tooth electrodes and the second comb tooth electrodes and made of a material having a relative dielectric constant greater than 1; and
a base that fixedly supports or movably supports the first electrode, the second electrode, and the dielectric members, wherein the first electrode and/or the second electrode, and the dielectric members are capable of being relatively displaced from each other.

2. The electrostatic induced type electromechanical transducer according to claim 1, wherein
the base fixedly supports the first electrode and the dielectric members and movably supports the second electrode.

3. The electrostatic induced type electromechanical transducer according to claim 1, wherein
the base fixedly supports the first electrode and the second electrode and movably supports the dielectric members.

4. The electrostatic induced type electromechanical transducer according to claim 2, wherein
the dielectric members are arranged in the respective gaps between the first comb tooth electrodes and the second comb tooth electrodes.

5. The electrostatic induced type electromechanical transducer according to claim 2, wherein
the dielectric members are each arranged opposite to a front edge of each of the second comb tooth electrodes through a gap; and
the second electrode is movably supported and capable of being displaced in a direction orthogonal to both a first direction from the front edge of each of the second comb tooth electrodes toward the dielectric members and a second direction from the second comb tooth electrodes toward the first comb tooth electrodes.

6. The electrostatic induced type electromechanical transducer according to claim 2, wherein
kinetic energy of the second electrode or the dielectric members being movably supported is converted into electric energy and is output.

7. The electrostatic induced type electromechanical transducer according to claim 1, wherein
on a surface of at least one of the first comb tooth electrodes or the second comb tooth electrodes is formed of an electret made of a SiO₂ layer containing alkali ions.

8. The electrostatic induced type electromechanical transducer according to claim 2, further comprising:
a third electrode having a plurality of third comb tooth electrodes arranged at the base; and
a fourth electrode having a plurality of fourth comb tooth electrodes arranged meshed with the plurality of third comb tooth electrodes through respective gaps and provided at the movable part, wherein
the plurality of dielectric members and the second electrode are fixed to the fixed part and a boosted output is taken out from the third electrode.

9. Nano tweezers comprising:
a pair of grippers being openable and closable;
the electrostatic induced type electromechanical transducer according to claim 4 provided in correspondence to at least one of the pair of grippers; and
a drive control unit that applies voltage between the first electrode and the second electrode of the electrostatic induced type electromechanical transducer to control the electrostatic induced type electromechanical transducer to drive the grippers to open or close.
